(19) United States
(12) Patent Application Publication
(10) Pub. No.: US 2013/0303239 A1
(43) Pub. Date: Nov. 14, 2013

(54) DEVICE AND METHOD FOR PREVENTING PERFORMANCE DEGRADATION OF VOICE COMMUNICATION IN WIRELESS TERMINAL

(71) Applicant: SAMSUNG ELECTRONICS CO., LTD., GYEONGGI-DO (KR)

(72) Inventor: Se-Won Park, Daegu (KR)

(73) Assignee: SAMSUNG ELECTRONICS CO., LTD., GYEONGGI-DO (KR)

(21) Appl. No.: 13/890,063

(22) Filed: May 8, 2013

(30) Foreign Application Priority Data
May 8, 2012 (KR) 10-2012-0048668

(51) Int. Cl. H04W 24/02

(52) U.S. Cl. CPC H04W 24/02
USPC 455/557

(57) ABSTRACT

A device is configured to perform a method for preventing performance degradation of voice communication in a wireless terminal connected to an external storage device, which enables the wireless terminal to perform the voice communication without performance degradation. The device includes a controller configured to, when a call occurs during performing of data communication with an external storage device connected to the wireless terminal, control to interrupt connection of the data communication and perform voice communication.

### CROSS-REFERENCE TO RELATED APPLICATION(S) AND CLAIM OF PRIORITY

The present application is related to and claims the priority under 35 U.S.C. §119(a) of an application entitled “Device and Method for Preventing Performance Degradation of Voice Communication in Wireless Terminal” filed in the Korean Industrial Property Office on May 8, 2012 and assigned Serial No. 10-2012-0048668, the contents of which are hereby incorporated by reference.

### TECHNICAL FIELD OF THE INVENTION

The present disclosure relates to a device and a method for preventing performance degradation of voice communication in a wireless terminal, and more particularly to a device and a method for preventing performance degradation of voice communication in a wireless terminal connected to an external storage device, which enable the wireless terminal to perform the voice communication without performance degradation.

### BACKGROUND OF THE INVENTION

In general, an On-The-Go (OTG) connector is used to connect an external storage device such as an external USB storage device or a storage media to a wireless terminal.

When one side of the OTG connector is inserted into a USB connector of the wireless terminal and an opposite side of the connector is connected to an external storage device, the wireless terminal may perform data communication for transmitting or receiving data to or from the external storage device

However, when voice communication is performed while the wireless terminal performs the data communication with the external storage device, it is problematic in that radiation performance of the voice communication is degraded. This is because the USB connector of the wireless terminal in which the OTG connector is inserted is often disposed adjacent to an antenna. The USB connector influences the degradation of the radiation performance of voice communication due to being generally disposed in the vicinity of the antenna.

Therefore, in the prior art, in order to solve a problem as described above, a length of an OTG connector is modified for each wireless terminal according to a position where a USB connector is arranged in the wireless terminal. This causes a problem in that each wireless terminal may require an exclusive connector separately made for the wireless terminal.

### SUMMARY OF THE INVENTION

To address the above-discussed deficiencies of the prior art, it is a primary object to provide a device and a method for preventing performance degradation of voice communication in a wireless terminal connected to an external storage device, which enables the wireless terminal to perform the voice communication without performance degradation.

Another aspect of the present disclosure is to provide a device and a method for preventing performance degradation of voice communication in a wireless terminal connected to an external storage device, which enables the wireless terminal to perform voice communication without performance degradation, by removing noise through interrupting a connection of data communication with the external storage device when a call for the voice communication occurs in the wireless terminal.

In accordance with an aspect of the present disclosure, there is provided a device for preventing performance degradation of voice communication in a wireless terminal. The device includes a controller configured to, when a call occurs during performing of data communication with an external storage device connected to the wireless terminal, control to interrupt a connection of the data communication and perform voice communication.

In accordance with another aspect of the present disclosure, there is provided a method of preventing performance degradation of voice communication in a wireless terminal. The method includes determining whether a call occurs during performing of data communication with an external storage device connected to the wireless terminal. The method also includes, when a call occurs during performing of the data communication, interrupting a connection of the data communication and performing voice communication.

The present disclosure provides a device and a method for preventing performance degradation of voice communication in a wireless terminal. In addition, since it is not necessary to make an OTG connector for each model of wireless terminal, the present disclosure can solve a problem relating to development and management of the OTG connector.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a front view illustrating data communication between a wireless terminal and an external storage device according to an embodiment of the present disclosure;

FIG. 2 is a block diagram illustrating a construction of a wireless terminal according to an embodiment of the present disclosure;

FIG. 3 is a flowchart illustrating a process of performing voice communication without performance degradation of voice communication in a wireless terminal according to a first embodiment of the present disclosure; and

FIGS. 4A and 4B illustrate a flowchart of a process of performing voice communication without performance degradation of voice communication in a wireless terminal according to a second embodiment of the present disclosure.

### DETAILED DESCRIPTION OF THE INVENTION

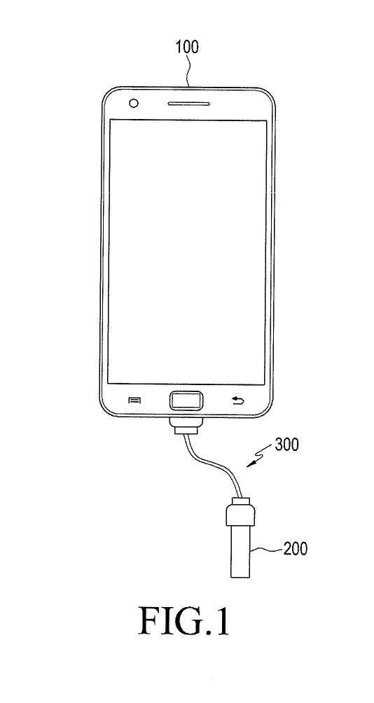

FIGS. 1 through 4B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. Hereinafter, exemplary embodiments of the present disclosure will be described in detail with reference to the accompanying drawings. In the following description, the same elements will be designated by the same reference numerals although they are shown in different drawings.

FIG. 1 is a front view illustrating data communication between a wireless terminal and an external storage device according to an embodiment of the present disclosure.

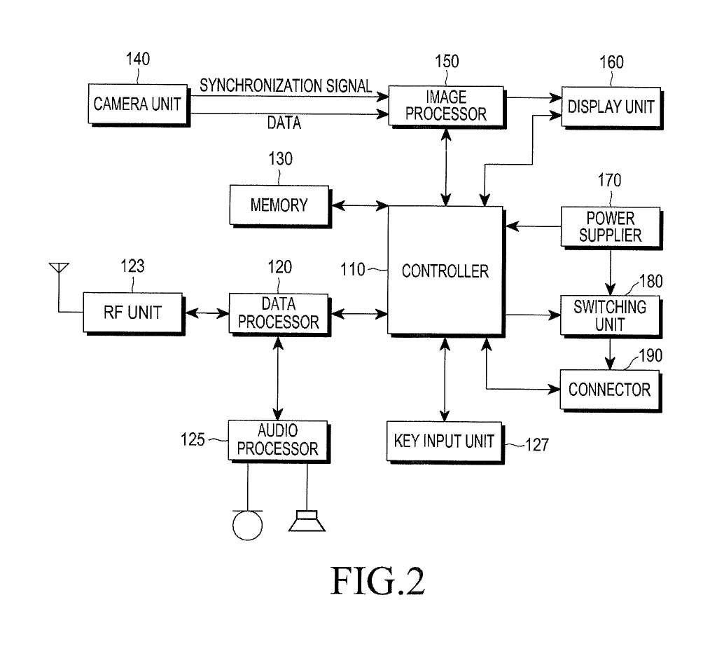

Referring to FIG. 1, a wireless terminal 100 is connected to an external storage device 200 through a connector 300 and transmits or receives data through a data communication with the external storage device 200. If a call occurs while the wireless terminal 100 performs data communication with the external storage device 200, the wireless terminal 100 interrupts the data communication with the external storage device 200 and connects the call to perform a voice communication. The construction of the wireless terminal 100 as described above will be described in more detail with reference to FIG. 2 below.

The connector 300 may be an OTG connector connecting the wireless terminal 100 with the external storage device 200.

The external storage device 200 stores data and is connected to the wireless terminal 100 through the connector 300 to transmit or receive data through the data communication. For example, the external storage device 200 may be a USB storage device that transmits or receives data through the data communication.

FIG. 2 is a block diagram illustrating a construction of a wireless terminal according to an embodiment of the present disclosure.

Referring to FIG. 2, an RF unit 123 performs a wireless communication function of a wireless terminal. The RF unit 123 includes an RF transmitter for up-converting and amplifying a frequency of a transmitted signal and an RF receiver for low-noise amplifying a received signal and down-converting a frequency of the received signal. A data processor 120 is equipped with a transmitter for encoding and modulating the transmitted signal and a receiver for demodulating and decoding the received signal. That is, the data processor 120 may be configured by a modem and a codec. Herein, the codec includes a data codec for processing packet data and an audio codec for processing an audio signal such as voice. An audio processor 125 performs a function of reproducing a received audio signal output from the audio codec of the data processor 120 or a function of transmitting an audio signal generated by a microphone to the audio codec of the data processor 120.

A key input unit 127 is equipped with keys for inputting information of numbers and characters, and function keys for setting various functions.

A memory 130 may include a program memory and a data memory. The program memory may store programs for controlling typical operations of a wireless terminal and control programs for interrupting data communication with the external storage device when a call occurs while the wireless terminal performs the data communication with the external storage device, according to an embodiment of the present disclosure. In addition, the data memory performs a function of temporarily storing data generated while executing the programs.

A controller 110 performs a function of controlling general operations of the wireless terminal.

According to an embodiment of the present disclosure, when a call occurs while the controller 110 performs data communication with the external storage device 200 connected to the connector 190 of the wireless terminal 100, the controller 110 controls to interrupt the data communication and perform voice communication by shutting off a power supply to the external storage device 200 through a switching unit 180. In addition, according to an embodiment of the present disclosure, when the external storage device 200 is connected to the connector 190 of the wireless terminal 100, the controller 110 controls to supply power to the external storage device 200 by turning on the switching unit 180.

According to an embodiment of the present disclosure, when a call is received or originated while the controller 110 performs data communication with the external storage device 200 connected to the connector 190 of the wireless terminal 100, the controller 110 controls to interrupt the data communication by shutting off the power supply to the external storage device 200 through automatically turning off the switching unit 180.

According to an embodiment of the present disclosure, when a call has been received or originated while the controller 110 performs data communication with the external storage device 200 connected to the connector 190 of the wireless terminal 100, the controller 110 displays a message for notifying of the interruption of the data communication during voice communication. When connection of the voice communication is selected during displaying of the message, the controller 110 controls to interrupt the data communication by turning off the switching unit 180 to shut off the power supply to the external storage device 200. During displaying of a message notifying of the interruption of the data communication, when cancellation of voice communication has been selected during voice communication, the controller 110 controls to terminate the connection of the voice communication and restart the data communication with the external storage device 200.

According to an embodiment of the present disclosure, when the voice communication is terminated, the controller 110 controls to supply power to the external storage device 200 by turning on the switching unit 180 and perform the data communication with the external storage device 200 again.

According to another embodiment of the present disclosure, while the controller 110 performs the data communication with the external storage device 200 connected to the connector 190 of the wireless terminal 100, when a call is received or originated and connection of voice communication is selected in a message for notifying of the interruption of connection of the data communication, the controller 110 may control to interrupt the connection of the data communication by shutting off the data communication between the wireless terminal 100 and the external storage device 200. In this event, the controller 110 can supply power to the external storage device 200 and interrupt the data communication between the wireless terminal 100 and the external storage device 200. Furthermore, when the voice communication is terminated, the controller 110 controls to perform the data communication again by releasing the interruption of the data communication between the wireless terminal 100 and the external storage device 200.

A camera unit 140 includes a camera sensor for capturing image data and converting a captured optical signal to an electric signal and a signal processor for converting an analog image signal captured by the camera sensor to digital data. It is assumed that the camera sensor is a CCD (Charge Couple Device) or CMOS (Complementary Metal Oxide Semiconductor) sensor and it is possible to implement the signal processor by a Digital Signal Processor (DSP). Furthermore, the camera sensor and the signal processor may be implemented either integrally or separately. The image processor 150 performs Image Signal Processing (ISP) for displaying an image signal output from the camera unit 140 to a display unit 160. The ISP performs functions such as gamma calibration, interpolation, spatial change, image effect, image scale, AWB (Auto White Balance), AE (Auto Exposure), AF (Auto Focus) or the like. Therefore, the image processor 150 processes an image signal output from the camera unit 140 in units of frames and outputs the frame image data according to a characteristic and size of the display unit 160. In addition, the image processor 150 includes an image codec and performs a function of compressing frame image data displayed in the display unit 160 according to a preset scheme or a function of reconstructing compressed frame image data to original frame image data. The image codec may be a JPEG codec, a MPEG4 codec, a wavelet codec, and so on. The image processor 150 is assumed to have an On Screen Display (OSD) function and can output OSD data depending on a size of a screen displayed under control of the controller 110.

The display unit 160 displays the image signal output from the image processor 150 on a screen and user data output from the controller 110. The display unit 160 may be implemented by an LCD. In an embodiment, the display unit 160 may include an LCD controller, a memory capable of storing image data, and an LED indicating element. When the display unit 160 is implemented by the LCD in a touch screen scheme, it may operate as an input unit. In this embodiment, keys such as the key input unit 127 may be displayed in the display unit 160.

A power supplier 170 supplies power to a wireless terminal. When the connector 300 connected to the external storage device 200 is inserted into the connector 190, the power supplier 170 supplies power to or interrupts the power supply to the external storage device 200 according to the switching on/off of the switching unit 180.

When the connector 300 connected with the external storage device 200 is inserted into the connector 190, the switching unit 180 is switched on and thus supplies power received from the power supplier 170 to the external storage device 200. When a call occurs during data communication between the wireless terminal 100 and the external storage device 200 connected through the connector 190, the switching unit 180 is switched off and thus interrupts the power supply from the power supplier 170 to the external storage device 200.

When the connector 300 connected to the external storage device 200 is inserted in the connector 190, the connector 190 transmits information reporting this insertion to the controller 110 and performs data communication between the wireless terminal 100 and the external storage device 200.

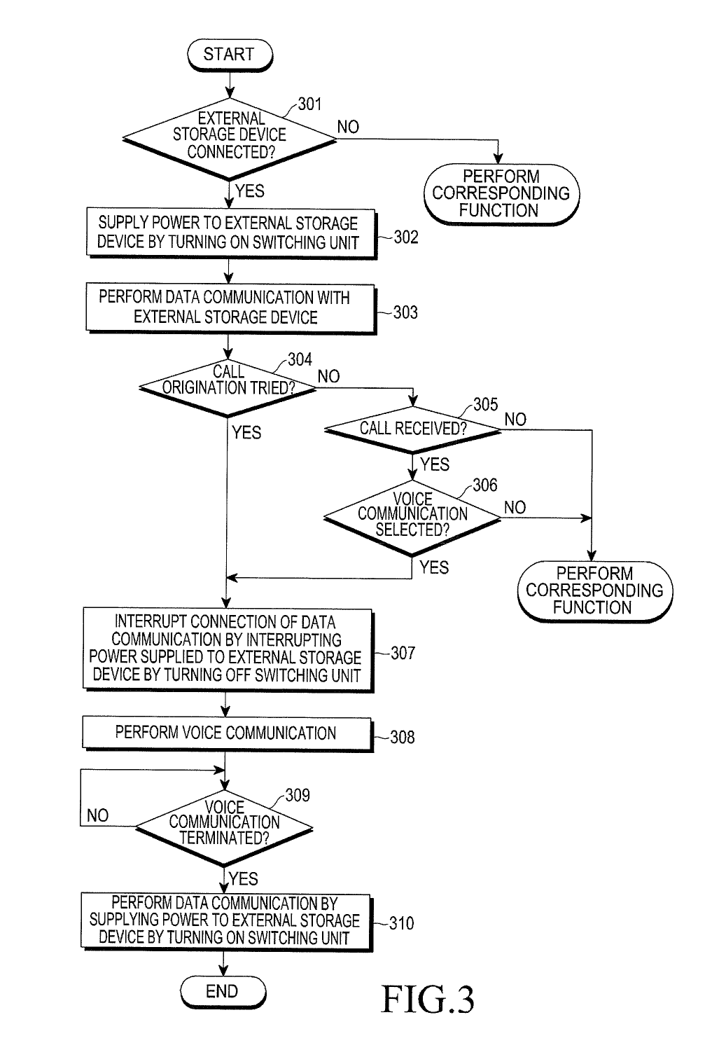

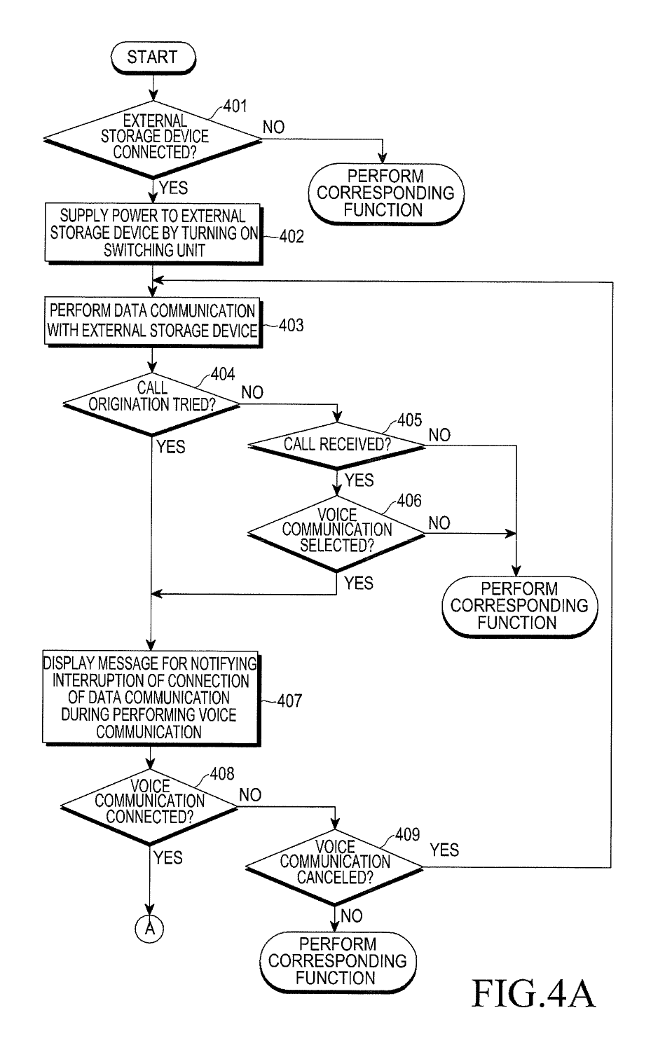

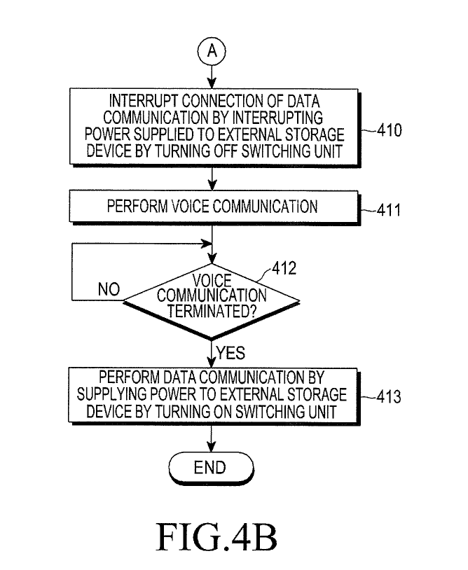

An operation of performing voice communication without performance degradation in a wireless terminal connected to an external storage device as described above will be described in more detail with reference to FIGS. 3 to 4B. In FIGS. 3 to 4B, interruption of data communication between the wireless terminal and the external storage device through interruption of a power supply to an external storage device will be described as an example. FIG. 3 is a flowchart illustrating a process of performing voice communication without performance degradation in a wireless terminal according to a first embodiment of the present disclosure.

Hereinafter, an embodiment of the present disclosure will be described in more detail with reference to FIG. 3 together with FIGS. 1 and 2.

Referring to FIG. 3, when the connector 300 is inserted into a connector 190 of the wireless terminal 100 and a voltage is applied to the connector 190 from the external storage device 200 according to the connection of the external storage device 200 to the connector 300, the connector 190 enables the voltage from the external storage device 200 to be applied to the controller 110.

Through the voltage applied from the connector 190, the controller 110 determines that the external storage device 200 has been connected to the connector 190 in block 301 and then supplies power output from the power supplier 170 to the external storage device 200 through the connector 190 by turning on the switching unit 180 in block 302.

The controller 110 proceeds to block 303, in which data is transmitted and received for data communication between the wireless terminal 100 and the external storage device 200.

During the data communication between the wireless terminal 100 and the external storage device 200, when a call origination is attempted, the controller 110 detects the attempt in block 304 and proceeds to block 307.

Alternatively, during the data communication between the wireless terminal 100 and the external storage device 200, when a call is received, the controller 110 detects the call reception in block 305 and notifies of the call occurrence. In this event, when voice communication is selected by a user, the controller 110 detects the selection in block 306 and proceeds to block 307.

In block 307, the controller 110 interrupts power supplied to the external storage device 200 by turning off the switching unit 180. As a result, the controller 110 interrupts the data communication between the wireless terminal 100 and the external storage device 200 in block 307.

After connection of the data communication with the external storage device 200 is interrupted, the controller 110 proceeds to block 308 for making a call connection for a voice communication.

Then, when the voice communication is terminated, the controller 110 detects the termination in block 309. Then, in block 310, the controller 110 turns on the switching unit 180 to supply the power output from the power supplier 170 to the external storage device 200 through the connector 190 and performs data communication with the external storage device 200 again.

FIGS. 4A and 4B illustrate a flowchart of a process of performing a voice communication without performance degradation in a wireless terminal according to a second embodiment of the present disclosure.

Hereinafter, an embodiment of the present disclosure will be described in more detail with reference to FIGS. 4A and 4B together with FIGS. 1 and 2.

Referring to FIGS. 4A and 4B, when the connector 300 is inserted into the connector 190 of the wireless terminal 100 and a voltage from the external storage device 200 is applied to the connector 190 according to the connection of the external storage device 200 to the connector 300, the connector 190 enables the voltage from the external storage device 200 to be applied to the controller 110.

In block 401, through the voltage applied from the connector 190, the controller 110 determines that the external storage device 200 has been connected to the connector 190. Then, in block 402, the controller 110 supplies power output from the power supplier 170 to the external storage device 200 through the connector 190 by turning on the switching unit 180.

Then, in block 403, data is transmitted and received for data communication between the wireless terminal 100 and the external storage device 200.

During the data communication between the wireless terminal 100 and the external storage device 200, when a call origination is attempted, the controller 110 detects the attempt in block 404. Then, the controller 110 proceeds to block 407, in which a message for notifying of the automatic interruption of the connection of data communication with the external storage device during voice communication is displayed.

Alternatively, during the data communication between the wireless terminal 100 and the external storage device 200, when a call is received, the controller 110 detects the call reception in block 405 and notifies of the call occurrence. In this event, when voice communication is selected by a user, the controller 110 detects the selection in block 406 and proceeds to block 407.

While a message for notifying of the automatic interruption of the connection of data communication with the external storage device during voice communication is displayed in block 407, when connection of voice communication has been selected during voice communication, the controller 110 detects the connection in block 408. Then, in block 410, the controller 110 turns off the switching unit 180, interrupts power supplied to the external storage device 200, and thereby interrupts the data communication between the wireless terminal 100 and the external storage device 200.

However, while a message for notifying of the automatic interruption of the connection of data communication with the external storage device during voice communication is displayed in block 407, when cancellation of voice communication is selected, the controller 110 detects the cancellation in block 409 and proceeds to block 403 of restarting the data communication with the external storage device 200.

After interrupting connection of data communication with the external storage device 200 in block 410, the controller 110 proceeds to block 411 in which voice communication is performed.

Then, when the voice communication is terminated, the controller 110 detects the termination in block 412. Then, in block 413, the controller 110 turns on the switching unit 180 to supply the power output from the power supplier 170 to the external storage device 200 through the connector 190 and performs data communication with the external storage device 200 again.

Embodiments of the present disclosure described above may be implemented in various ways. For example, embodiments of the present disclosure may be implemented using hardware, software, or a combination thereof. Embodiments can be implemented as software executed on at least one processor using various operation systems or platforms. Additionally, such software may be made in any one among a plurality of appropriate programming languages, and may be compiled as machine codes or medium codes executed in a framework or virtual machine.

In situations where embodiments of the present disclosure are executed on at least one processor, it is possible to implement one or more programs for performing a method of implementing various embodiments of the present disclosure as described above as a recorded processor readable medium (e.g. memory, floppy disk, compact disk, optical disk or magnetic tape).

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A device for preventing performance degradation of voice communication in a wireless terminal, the device comprising:
a controller configured to, when a call occurs during performing of data communication with an external storage device connected to the wireless terminal, control to interrupt a connection of the data communication and perform voice communication.

2. The device as claimed in claim 1, further comprising:
a switching unit configured to switch a power supply between a power supplier and the external storage device connected to the wireless terminal,
wherein the controller is configured to control to interrupt connection of the data communication by shutting off the power supply to the external storage device through the switching unit.

3. The device as claimed in claim 1, wherein, when the external storage device is connected to the wireless terminal, the controller controls to supply power to the external storage device by turning on the switching unit.

4. The device as claimed in claim 1, wherein, when a call is received or originated during performing of the data communication with the external storage device connected to the wireless terminal, the controller controls to interrupt connection of the data communication by shutting off the power supply to the external storage device by automatically turning off the switching unit.

5. The device as claimed in claim 1, wherein, when a call is received or originated during performing of the data communication with the external storage device connected to the wireless terminal, the controller displays a message for notifying of the interruption of the data communication during performing of the voice communication, and when connection of the voice communication is selected during displaying of the message, the controller controls to interrupt the connection of the data communication by turning off the switching unit to shut off the power supply to the external storage device.

6. The device as claimed in claim 5, wherein, during displaying of the message notifying of the interruption of the data communication, when cancellation of the voice communication is selected during performing of the voice communication, the controller controls to terminate the connection of the voice communication and restart data communication with the external storage device.

7. The device as claimed in claim 1, wherein, when performing of the voice communication is terminated, the controller controls to supply the power to the external storage device by turning on the switching unit and perform data communication again with the external storage device.

8. The device as claimed in claim 1, further comprising:
a connector connected to the external storage device,
wherein the connector connected to the external storage device is inserted into the connector.

9. The device as claimed in claim 8, wherein, when the external storage device is a USB storage device, the connector is an On-The-Go (OTG) connector.

10. A method of preventing performance degradation of voice communication in a wireless terminal, the method comprising:
determining whether a call occurs during performing of data communication with an external storage device connected to the wireless terminal; and
when a call occurs during performing of the data communication, interrupting a connection of the data communication and performing voice communication.

11. The method as claimed in claim 10, further comprising:
when the external storage device is connected to the wireless terminal, supplying power to the external storage device.

12. The method as claimed in claim 11, wherein supplying of the power comprises:
when the external storage device is connected through a connector inserted into the wireless terminal, supplying the power to the external storage device.

13. The method as claimed in claim 12, wherein, when the external storage device is a USB storage device, the connector is an On-The-Go (OTG) connector.

14. The method as claimed in claim 10, wherein performing of the voice communication comprises:
when a call is received or originated during performing of the data communication, interrupting the connection of the data communication by automatically shutting off the power supply to the external storage device.

15. The method as claimed in claim 10, wherein performing of the voice communication comprises:
when a call is received or originated during performing of the data communication, displaying a message for notifying of the interruption of the data communication during performing of the voice communication; and
when the connection of the voice communication is selected during displaying of the message, interrupting the connection of the data communication by shutting off the power supply to the external storage device.

16. The method as claimed in claim 15, further comprising:
when cancellation of the voice communication is selected during displaying of the message, terminating the connection of the voice communication and restarting data communication with the external storage device.

17. The method as claimed in claim 10, further comprising:
when performing of the voice communication is terminated, supplying the power to the external storage device and performing data communication again with the external storage device.

18. A non-transitory computer readable medium encoded with a computer program, the computer program comprising computer readable program code for:
determining whether a call occurs during performing of data communication with an external storage device connected to the wireless terminal; and
when a call occurs during performing of the data communication, interrupting a connection of the data communication and performing voice communication.

19. The non-transitory computer readable medium of claim 18, further comprising computer readable program code for:
when the external storage device is connected to the wireless terminal, supplying power to the external storage device.

20. The non-transitory computer readable medium of claim 19, wherein supplying of the power comprises:
when the external storage device is connected through a connector inserted into the wireless terminal, supplying the power to the external storage device.
